(19) United States
(12) Patent Application Publication
(10) Pub. No.: US 2020/0002498 A1
(43) Pub. Date: Jan. 2, 2020

(54) POLYMER FOAM AND PREPARATION METHOD THEREOF

(71) Applicant: Dongguan Hailex Polymer Material Science And Technology Co., Ltd., Dongguan (CN)

(72) Inventors: Zhenhuan LUO, Dongguan (CN); Fuqi LIU, Dongguan (CN)

(21) Appl. No.: 16/148,461

(22) Filed: Oct. 1, 2018

(30) Foreign Application Priority Data
Jun. 29, 2018 (CN) 201810697803.5

(51) Int. Cl. C08J 9/12; C08J 9/00; B29C 44/02; B29C 44/34

(52) U.S. Cl. CPC C08J 9/122; C08J 9/0066; C08J 9/0023; B29C 44/02; B29C 44/3415; B29K 2509/02; C08J 2201/026; C08J 2203/08; C08J 2203/06; C08J 2323/08; C08J 2375/04; C08J 2205/044

(57) ABSTRACT

The present disclosure relates to a polymer foam and a preparation method thereof. The polymer foam is obtained by physically foaming a thermoplastic elastomer or a polyolefin material, and has an apparent density of 0.30 g/cm³ or less and a rebound degree of 50% or more as measured according to ASTM D2632.

### CROSS REFERENCE

This disclosure claims priority benefits from Chinese Patent Application No. 201810697803.5 filed on Jun. 29, 2018, which is incorporated by reference herein in its entirety.

### TECHNICAL FIELD

The present disclosure relates to the technical field of polymer material, and particularly to a physically foamed polymer foam and a preparation method thereof.

### BACKGROUND

Common pure substances have three phases of gas, liquid and solid. In a case where gas and liquid coexist, the density of the liquid phase is greater than that of the gas phase, but when the temperature and pressure of the system reach a particular point, the densities of the gas phase and of the liquid phase tend to be the same, and the two phases are combined into one homogeneous phase. This particular point is defined as the critical point of this substance, and the corresponding temperature, pressure and density are defined as the critical temperature (Tc), critical pressure (Pc), and critical density (ρc) of this pure substance respectively. Beyond this point, it cannot be liquefied no matter how the pressure increases, and it cannot return back to gas phase no matter how the temperature increases. This homogeneous phase above the critical temperature and the critical pressure is referred to as supercritical fluid. Generally, the physical properties of a supercritical fluid are between those of gas phase and those of the liquid phase. For example, a supercritical fluid has a viscosity close to gas, and a density close to liquid. Due to a high density, more supercritical fluid can be transported than gas, and due to a low viscosity, the energy (or power) required for transporting supercritical fluid is lower than that of liquid. A supercritical fluid has a diffusion coefficient 10-100 times higher than that of liquid, that is, the mass transfer resistance is much lower than that of liquid, so its mass transfer is quicker than that of liquid. In addition, a supercritical fluid has a surface tension as less as gas, so it can easily permeate into a porous tissue. In addition to the physical properties, the chemical properties of a supercritical fluid are also different from those of gas or liquid. For example, carbon dioxide in gas state has no extraction ability. However, when being in supercritical state, carbon dioxide becomes organophilic, and thus has an organic-dissolving ability, which varies depending on the temperature and pressure.

Conventionally, main methods for preparing a physically foamed polyolefin material include a gas-assisted injection molding method, a gas-assisted extrusion molding method and the like, with an alkane gas, a volatile compound, a supercritical fluid or the like being used as a physical foaming agent. However, the above methods cannot be used to prepare a foam material with a low density and a high rebound ability, and the foam material prepared cannot meet the requirements for an insole shoe material with a low density and a high rebound ability.

### SUMMARY

The inventors has carried out intensive studies and found out that by selecting a special polymer material to be foamed (a thermoplastic elastomer or a polyolefin material with a certain crosslinking degree), the rebound ability of polymer foam can be controlled within a prescribed range, thereby obtaining a polymer foam with both a low density and a high rebound ability.

One aspect of the present disclosure provides a polymer foam, which is obtained by physically foaming a thermoplastic elastomer or a polyolefin material, and has an apparent density of 0.30 g/cm³ or less and a rebound degree of 50% or more as measured according to ASTM D2632.

In some embodiments, the polyolefin material is doped with 0.15-1.1 phr (part by weight) of crosslinking agent relative to 100 phr of polyolefin material. By setting a suitable polyolefin/crosslinking agent ratio to control the crosslinking degree of the polyolefin within a proper range, a polyolefin foam with both a low density and a high rebound ability can be obtained through a physical foaming process.

In some embodiments, the polyolefin material may not be doped with a crosslinking agent. In this case, the crosslinking may be performed through an electron beam irradiation process, for example, by irradiating with 20-50 kGy (kilogrey) of high energy electron beam.

In some embodiments, the polymer foam is used as a floor mat, a shoe material, a sport equipment, a toy or a packaging material.

In some embodiments, the polymer foam as a shoe material may have a density of 0.05-0.3 g/cm³, a vertical falling ball rebound degree of 50% or more, and a cell diameter of 0.1-3 mm.

In some embodiments, the polymer foam as a floor mat has a density of 0.03-0.2 g/cm³, and a cell diameter of 0.1-3 mm.

In some embodiments, as measured by a fatigue durability test repeated 20,000 times at a frequency of 3 Hz (3 times/second) under a load of 10-80 kg, the dimensional stability of the polymer foam of the present disclosure is improved by 30% or more as compared with a conventional EVA (poly (ethylene-co-vinyl acetate)) chemical foaming material.

In some embodiments, the retention of vertical falling ball rebound ability after 10-60 days of the polymer foam is improved by 30% or more as compared with a conventional EVA chemical foaming material.

Another aspect of the present disclosure provides a method for preparing the polymer foam as described above, comprising:

(1) making a thermoplastic elastomer or a polyolefin material into a blank by using an injector, an extruder or a molding press, wherein the polyolefin material is optionally doped with a crosslinking agent in an amount of 0.15-1.1 phr (part by weight) relative to 100 phr of the polyolefin material;

(2) when the crosslinking agent is doped, subjecting the polyolefin blank to a crosslinking reaction through the crosslinking agent, or when no crosslinking agent is doped, subjecting the polyolefin blank to a crosslinking reaction through an electron beam irradiation process with a 20-50 kGy (kilogrey) of high energy electron beam irradiation, to obtain a crosslinked polyolefin blank;

(3) impregnating the thermoplastic elastomer blank or the crosslinked polyolefin blank with a high pressure gas (10-50 MPa pressure) in an autoclave, then releasing the pressure to a normal pressure, to obtain a gas-impregnated blank; and

(4) subjecting the gas-impregnated blank to a first stage foaming, placing the foamed material of the first stage foaming into a setting mold to perform an in-mold setting, so as to obtain a final three-dimensional finished foam article; or

placing supercritical fluid-impregnated blank into an end-product mold to perform an 1:1 in-mold foaming, so as to obtain a finished foam article.

The above method of the present disclosure is environmental friendly and nontoxic, and the polymer foam prepared has a low density and a high rebound ability, with a rebound degree of 50% or more and a retention of rebound ability improved by 30% or more as compared with a conventional EVA chemical foaming material, and a high fatigue durability can also be achieved.

### DETAILED DESCRIPTION

The present disclosure aims at providing a polymer foam obtainable by physically foaming a thermoplastic elastomer or a polyolefin material, which has a low density and a high rebound ability. The physical foaming process of the present disclosure and the polymer foam obtained therefrom are described in details below.

—Starting Materials—

Starting materials useful in the polymer material physical foaming process of the present disclosure comprise a thermoplastic elastomer and a polyolefin material.

The thermoplastic elastomer may comprise at least one of a thermoplastic polyurethane (TPU), a thermoplastic polyester elastomer (TPEE), and a polyether block amide elastomer (Pebax), or a mixture thereof.

The polyolefin material may comprise at least one of poly(ethylene-co-vinyl acetate) (EVA), a polyolefin elastomer (POE), a low density polyethylene (LDPE), and an ethylene-propylene-diene-terpolymer rubber (EPDM), or a mixture thereof. For example, the polyolefin material may be EVA wherein the molar content of vinyl acetate is 5-40%, or may be a mixture of EVA/POE with a mixing ratio of 100/0.1˜0.1/100.

The polyolefin material may be doped with at least one of a crosslinking agent, a filler and/or an auxiliary agent. Here, relative to 100 phr of the polyolefin material, the crosslinking agent may have an amount of 1.2 phr or less, for example, 0.15-1.1 phr, preferably 0.25-1.0 phr, the filler may have an amount of 20 phr or less, and the auxiliary agent may have an amount of 5 phr or less.

The crosslinking agent may comprise a peroxide, such as dicumyl peroxide (DCP) and bis(tert-butylperoxyisopropyl)benzene (BIPB).

The filler may comprise at least one of calcium carbonate, talc, mica, pottery clay, zinc oxide, and titanium oxide.

The auxiliary agent may comprise at least one of paraffin, stearic acid or a salt thereof (zinc salt or calcium salt), or another long-chain fatty acid.

—Preparation of a Blank—

In the foaming process of the present disclosure, the above starting material (the thermoplastic elastomer or polyolefin material) is made into a blank with an injector, an extruder, or a molding press.

The preparation of the blank may be performed under a suitable condition. For example, for the polyolefin material to be crosslinked, a molding may be performed at a mold temperature of 160-180° C. and a suitable mold clamping pressure of e.g. about 10 MPa, for 400-550 seconds.

In the present disclosure, the shape of the blank is not particularly limited. Generally, the blank may be sheet-like, particulate, and so on.

After forming the blank, the polyolefin material may be subjected to a crosslinking reaction in order to increase the molecular chain strength of the polyolefin material. The crosslinking reaction may be performed with a chemical crosslinking process and/or an electron beam irradiation process. For example, the polyolefin blank may be crosslinked and molded at a temperature of 170-180° C. (by means of the crosslinking agent contained in the polyolefin composition), and a vulcanization curve measured with a vulcameter may be used as a reference for the crosslinking and molding. The crosslinking may also be performed through an electron beam irradiation process, for example, by irradiating with 20-50 kGy (kilogrey) of high energy electron beam.

—High Pressure Gas Impregnation—

The physical foaming process of the present disclosure further comprises subjecting the above blank to a high pressure impregnation with a high pressure gas to obtain a gas-impregnated blank.

The gas is an inactive gas, preferably carbon dioxide or nitrogen. Most preferably, the gas is a supercritical fluid.

For example, the thermoplastic elastomer blank or the crosslinked polyolefin blank may be subjected to a high pressure impregnation with a supercritical fluid in an autoclave, and then the pressure is released to a normal pressure, to obtain a supercritical fluid-impregnated blank.

The supercritical fluid may comprise carbon dioxide supercritical fluid, nitrogen supercritical fluid, and the like.

The high pressure impregnation may be performed at a pressure of 10-50 MPa and a temperature of 40-150° C. for 0.5-8 hours, preferably 1-5 hours.

The pressure releasing to a normal pressure after the high pressure impregnation is usually controlled within 15-40 minutes to meet the production efficiency requirement and control pre-foaming (pre-foaming ratio is controlled to be 1-1.4, where 1 represents no pre-foaming phenomena).

In the resultant supercritical fluid-impregnated blank, the impregnation amount of the supercritical fluid in the blank is 0.6-15% by weight, preferably 0.8-10% by weight.

—Foaming Process—

In the present disclosure, the gas-impregnated blank may be subjected to a foaming process in two ways. One comprises subjecting the gas-impregnated blank to a first stage foaming, then placing the foamed material of the first stage foaming into a setting mold to perform an in-mold setting. The other comprises subjecting the gas-impregnated blank to an in-mold foaming directly, that is, placing the gas-impregnated blank into an end-product mold to perform an 1:1 in-mold foaming, to obtain a finished foam article.

The first stage foaming is usually performed by placing the above blank into an oven at a temperature of 90-150° C. under a normal pressure for 5-30 minutes, to achieve a foaming ratio in a range of 1.8-2.5. After the first stage foaming, the density of the foaming material may be decreased from the initial about 1.0 g/cm³ to 0.09-0.18 g/cm³. The foamed article of the first stage foaming may be used in commercial applications.

However, with respect to a product design with a complex structure, the foamed material of the first stage foaming may be placed into a setting mold to perform an in-mold setting. The in-mold setting may comprise hot pressing at a mold temperature of 130-160° C. for 300-600 seconds, cooling with a normal temperature water for 500-800 seconds, and then opening the mold to take out the end-product with a structure same as the setting mold.

Further, the conditions for the in-mold foaming may comprise a temperature of 70-150° C. and a foaming time of 5-30 minutes.

A ratio between the linear dimension of the blank before in-mold foaming (the linear dimension is usually defined in a length direction) and the product dimension after the in-mold foaming may be 1:1.5˜1:3.5, preferably 1:1.7˜1:2.5.

After in-mold foaming, the density of the foaming material may be decreased from the initial about 1.0 g/cm³ to 0.30 g/cm³ or less, preferably 0.25 g/cm³ or less, and more preferably 0.20 g/cm³ or less.

—Polymer Foam—

The polymer foam of the present disclosure obtained from the above process may have an apparent density of 0.30 g/cm³ or less and a rebound degree of 50% or more as measured according to ASTM D2632.

The polymer foam may have a cell diameter of 0.01 mm or more and 4 mm or less, and an apparent density of 0.03 g/cm³ or more and 0.30 g/cm³ or less, preferably 0.03 g/cm³ or more and 0.25 g/cm³ or less, and more preferably 0.04 g/cm³ or more and 0.20 g/cm³ or less.

The polymer foam of the present disclosure may be used as a floor mat, a shoe material, a sport equipment, a toy or a packaging material.

When used as a shoe material, the polymer foam of the present disclosure may have a density of 0.05-0.3 g/cm³, a vertical falling ball rebound degree of 50% or more, and a cell diameter of 0.1-3 mm.

When used as a floor mat, the polymer foam of the present disclosure may have a density of 0.03-0.2 g/cm³, and a cell diameter of 0.1-3 mm.

The polymer foam of the present disclosure has excellent fatigue durability and property retention performance. For example, as measured by a fatigue durability test repeated 20,000 times at a frequency of 3 Hz (3 times/second) under a load of 10-80 kg, the dimensional stability of the polymer foam of the present disclosure may be improved by 30% or more as compared with a conventional EVA chemical foaming material. And the retention of vertical falling ball rebound ability after 10-60 days of the polymer foam of the present disclosure may also be improved by 30% or more as compared with a conventional EVA chemical foaming material.

The present disclosure will be further described below through examples and comparative examples. However, the present disclosure is not limited to these examples and comparative examples in any way.

The analysis and test methods used in the examples and comparative examples are as follows:

(1) the cell diameter of a foamed article is measured with an optical microscope, and the material density is measured with a specific gravity balance;

(2) the rebound ability is tested according to ASTM D2632:

according to ASTM D2632 standard, the test is performed by freely falling a steel ball with a prescribed diameter and a prescribed mass from a prescribed height onto a foam plastic sample, where the ratio between the maximum height to which the steel ball rebound and the falling height is the rebound percentage (rebound degree); and

(3) fatigue durability test: the fatigue durability test is repeated 20,000 times at a frequency of 3 Hz (3 times/second) under a load of 10-80 kg, and the change in dimension of the foamed article is measured.

### Example 1

100 phr of EVA (EVA7470 from Formosa Plastic, with a molar content of vinyl acetate of 26%), 1 phr of calcium carbonate, 0.5 phr of paraffin, and 0.4 phr of DCP were mixed under conditions of a temperature of 100-120° C. and a pressure of 0.75 MPa in a Banbury mixer ST-75L (from Santai Machinery Company) for 12 min After discharging, the above mixture was extruded and granulated with an extrusion granulator which matches the Banbury mixer ST-75L. The colloidal particles were crosslinked and molded at a mold temperature of 180° C. in a KM-E308L3 EVA injector (from Jumin Machinery Company).

The crosslinked polyolefin blank was placed into an autoclave, a carbon dioxide supercritical fluid was injected thereto, and a pressure of 40 MPa and a temperature of 50° C. were maintained for 2 hours. Then, the pressure was released to a normal pressure over 30 min, to obtain a supercritical fluid-impregnated blank (with a pre-foaming ratio of 1.5 or less), and the impregnation amount of the supercritical fluid in the blank is about 10% by weight. (The carbon dioxide supercritical fluid in this step may be replaced with a nitrogen supercritical fluid).

The above supercritical fluid-impregnated blank was placed into an end-product mold, and subjected to an in-mold foaming at a temperature of 140° C. for 15 min, to obtain a finished foam article. The foaming ratio, as a ratio between the linear dimension of the blank in a length direction before foaming and the dimension of the product after the in-mold foaming, is 1.8.

The cell diameter of the finished foam article was measured with an optical microscope; the material density was measured with a specific gravity balance; and the rebound ability was tested according to ASTM D2632: the test was performed by freely falling a standard steel ball with a mass of 28±0.5 g from a height of 400 mm onto the foam plastic sample, and the ratio between the maximum height to which the steel ball rebound and the falling height was calculated as the rebound percentage (rebound degree).

The cell diameter, density, rebound degree, and retention of rebound ability after 30 days of the finished foam article were shown in Table 1.

### Example 2

A finished foam article was obtained with the same procedure as Example 1, except that an EVA (with a molar content of vinyl acetate of 26%)/POE (POE 8150, from Dow Chemical Corporation) mixture at a mixing ratio of 60:40 was used instead of EVA.

The cell diameter, density, rebound degree, and retention of rebound ability after 30 days of the finished foam article were measured and shown in Table 1.

### Example 3

A finished foam article was obtained with the same procedure as Example 1, except that TPU (UE-85AU10, from Covestro Corporation) was used instead of the EVA and the mixing and crosslinking steps were omitted.

The cell diameter, density, rebound degree, and retention of rebound ability after 30 days of the finished foam article were measured and shown in Table 1.

### Example 4

The procedure of Example 1 was repeated, except that a first stage foaming and a subsequent in-mold setting were used instead of the in-mold foaming. The gas-impregnated blank was placed into an oven at a temperature of 130° C. to perform foaming, the foaming time was 20 minutes, and the foaming ratio was about 2.0. Then, the foamed material of the first stage foaming was placed into a setting mold to perform the in-mold setting. The in-mold setting comprises hot pressing at a mold temperature of 130-160° C. for 300-600 seconds, cooling with a normal temperature water for 500-800 seconds, and then opening the mold to take out the product, thereby obtaining the polymer foam of Example 4.

The cell diameter, density, rebound degree, and retention of rebound ability after 30 days of the finished foam article were measured and shown in Table 1.

### Example 5

The polymer foam of Example 5 was obtained with the same procedure as Example 4, except that the foaming process only comprised the first stage foaming, and the in-mold setting was omitted.

The cell diameter, density, rebound degree, and retention of rebound ability after 30 days of the finished foam article were measured and shown in Table 1.

### Example 6

The formulation was the same as in Example 1 except that no peroxide crosslinking agent was used. The crosslinking was performed through a high energy electron beam irradiation process with 20-50 kGy (kilogrey) of high energy electron beam irradiation. Then, the same foaming procedure as in Example 5 was used to obtain the polymer foam of Example 6.

The cell diameter, density, rebound degree, and retention of rebound ability after 30 days of the finished foam article were measured and shown in Table 1.

### Comparative Example 1

The procedure was the same as Example 1, except that the amount of the crosslinking agent DCP in the formulation was changed to 1.25 phr. The cell diameter, density, rebound degree, and retention of rebound ability after 30 days of the foam product were measured and shown in Table 1.

### Comparative Example 2

The procedure was the same as Example 4, except that the amount of the crosslinking agent DCP in the formulation was changed to 0.12 phr. The cell diameter, density, rebound degree, and retention of rebound ability after 30 days of the foam product were measured and shown in Table 1.

### Comparative Example 3

The procedure was the same as Example 5, except that the amount of the crosslinking agent DCP in the formulation was changed to 0.12 phr. The cell diameter, density, rebound degree, and retention of rebound ability after 30 days of the foam product were measured and shown in Table 1.

### Comparative Example 4

A TPU foam product was prepared with a conventional Mucell technology by using a supercritical fluid foaming equipment. The barrel temperature of the injection molding machine was 210° C., and the mold temperature was 30° C. Using a Mucell equipment, a nitrogen supercritical fluid was injected into the metering section of the injection molding machine and mixed with a TPU melt, then the fluid-mixed TPU melt was injection molded into a mold for molding. In the mold cavity, the supercritical fluid was gasified inside and outside the TPU melt and generated internal cells, as a result, an injection molded and foamed TPU article having a dimension the same as that of the mold cavity and non-smooth surface with gas marks was obtained. The cell diameter, density, rebound degree, and retention of rebound ability after 30 days of the foamed product were measured and shown in Table 1.

TABLE 1

| | Cell | | Rebound | Retention of rebound |
|---|---|---|---|---|
| | diameter | | degree | ability after 30 days |
| | (mm) | Density | (%) | (%) |
| Example 1 | 0.5-2.5 | 0.2 | 50 | 93 |
| Example 2 | 0.5-4 | 0.18 | 60 | 94 |
| Example 3 | 0.01-0.5 | 0.28 | 56 | 98 |
| Example 4 | 0.2-1.5 | 0.17 | 56 | 94 |
| Example 5 | 0.3-2.8 | 0.14 | 58 | 95 |
| Example 6 | 0.1-2 | 0.15 | 56 | 95 |
| Comparative | 0.1-0.8 | 0.32 | 40 | 90 |
| Example 1 | | | | |
| Comparative | 0.1-1.5 | 0.42 | 35 | 88 |
| Example 2 | | | | |
| Comparative | 0.1-1.8 | 0.35 | 42 | 90 |
| Example 3 | | | | |
| Comparative | 0.8-2 | 0.55 | 50 | 98 |
| Example 4 | | | | |

As seen from above, Example 3 can obtain a foam article with a lower density (more light-weight) and a smoother surface of the appearance as compared with the Mucell injection molded TPU foam article in Comparative Example 4.

What is claimed is:

1. A polymer foam, which is obtained by physically foaming a thermoplastic elastomer or a polyolefin material, and has an apparent density of 0.30 g/cm³ or less and a rebound degree of 50% or more as measured according to ASTM D2632.

2. The polymer foam according to claim 1, wherein the polymer physical foam has a cell diameter of 0.01 mm or more and 4 mm or less, and an apparent density of 0.03 g/cm³ or more and 0.30 g/cm³ or less.

3. The polymer foam according to claim 1, wherein the thermoplastic elastomer comprises at least one of a thermoplastic polyurethane (TPU), a thermoplastic polyester elastomer (TPEE), and a polyether block amide elastomer (Pebax), or a mixture thereof.

4. The polymer foam according to claim 1, wherein the polyolefin material comprises at least one of poly(ethylene-co-vinyl acetate) (EVA), a polyolefin elastomer (POE), a low density polyethylene (LDPE), and an ethylene-propylene-diene-terpolymer rubber (EPDM), or a mixture thereof; and the polyolefin material is optionally doped with at least one of a crosslinking agent, a filler, and an auxiliary agent.

5. The polymer foam according to claim 4, wherein the crosslinking agent comprises a peroxide.

6. The polymer foam according to claim 4, wherein the filler comprises at least one of calcium carbonate, talc, mica, pottery clay, zinc oxide, and titanium oxide.

7. The polymer foam according to claim 4, wherein the auxiliary agent comprises at least one of paraffin, a stearate, or another long-chain fatty acid.

8. The polymer foam according to claim 1, wherein the polymer foam is formed by impregnating the thermoplastic elastomer or the polyolefin material with a high pressure gas, and then foaming by heating the impregnated material, wherein the polyolefin material is subjected to a crosslinking reaction to form a crosslinked polyolefin material, before it is impregnated with the high pressure gas.

9. The polymer foam according to claim 8, wherein the crosslinked polyolefin material is obtained by doping a crosslinking agent in an amount of 0.15-1.1 parts by weight relative to 100 parts by weight of the polyolefin material, and subjecting the doped polyolefin material to a chemical crosslinking reaction, or when no crosslinking agent is doped, subjecting the polyolefin material to a crosslinking reaction through an electron beam irradiation process with a 20-50 kGy of high energy electron beam irradiation.

10. The polymer foam according to claim 8, wherein the gas is carbon dioxide or nitrogen.

11. The polymer foam according to claim 8, wherein the gas is a supercritical fluid.

12. The polymer foam according to claim 1, which is used as a floor mat, a shoe material, a sport equipment, a toy or a packaging material.

13. A method for preparing the polymer foam according to claim 1, comprising:
(1) making a thermoplastic elastomer or a polyolefin material into a thermoplastic elastomer blank or a polyolefin blank by using an injector, an extruder or a molding press, wherein the polyolefin material is optionally doped with a crosslinking agent in an amount of 0.15-1.1 parts by weight relative to 100 parts by weight of the polyolefin material;
(2) when the crosslinking agent is doped, subjecting the polyolefin blank to a crosslinking reaction through the crosslinking agent, or when no crosslinking agent is doped, subjecting the polyolefin blank to a crosslinking reaction through an electron beam irradiation process with a 20-50 kGy of high energy electron beam irradiation, to obtain a crosslinked polyolefin blank;
(3) impregnating the thermoplastic elastomer blank or the crosslinked polyolefin blank with a high pressure gas having a pressure of 10-50 MPa in an autoclave, then releasing the pressure to a normal pressure, to obtain a gas-impregnated blank; and
(4) subjecting the gas-impregnated blank to a first stage foaming, placing the foamed material of the first stage foaming into a setting mold to perform an in-mold setting, so as to obtain a final three-dimensional finished foam article; or
placing the supercritical fluid-impregnated blank into an end-product mold to perform an 1:1 in-mold foaming, so as to obtain a finished foam article.
